(19) United States
(12) Patent Application Publication
(10) Pub. No.: US 2025/0013970 A1
(43) Pub. Date: Jan. 9, 2025

(54) Technologies for Dynamically Filtering Data Fragments for Sharing Among Recipient Parties

(71) Applicant: PROJECT44, LLC, Chicago, IL (US)

(72) Inventors: Matthew Galloway, Chicago, IL (US); Troy Mass, Oak Park, IL (US); Alexander Lukasik, Oak Lawn, IL (US); Wesley Hart, Rocklin, CA (US); Hereen Oh, Chicago, IL (US); Gustavo Clavijo, Chicago, IL (US); Lorena Garcia, Chicago, IL (US); Maya Lake, Chicago, IL (US)

(21) Appl. No.: 18/218,468

(22) Filed: Jul. 5, 2023

(51) Int. Cl. G06Q 10/083; G06Q 10/10

(52) U.S. Cl. CPC G06Q 10/083; G06Q 10/103

(57) ABSTRACT

Technologies for dynamically filtering data fragments for sharing among recipient parties are disclosed herein. An example method includes receiving a data fragment update corresponding to a data fragment of a set of data fragments associated with a shareable entity, and determining to share the data fragment update with the recipient party without evaluating a sharing rule. The example method further includes cloning the data fragment update to generate an identical data fragment update, and filtering the identical data fragment update according to filtering requirements of the sharing rule associated with the recipient party. The example method further includes sharing the filtered identical data fragment update to a device associated with the recipient party.

### FIELD OF THE DISCLOSURE

The present disclosure generally relates to technologies for sharing logistics data, and more particularly, to dynamically filtering data fragments for sharing among recipient parties.

### BACKGROUND

Supply chain logistics is a complicated field that can involve numerous parties working together as part of a single supply chain to produce/provide certain products/goods. Tracking the activities of parties within such complicated supply chains is a critical logistics component for each party within the supply chain as they plan functions/activities around the delivery of shipped products/goods. As such, development of technologies that can reliably provide relevant logistics data of supply chain parties is a topic of great interest in the field of supply chain logistics.

In particular, collaboration is crucial in empowering parties operating together on a supply chain, as well as any industry where parties work together through a platform-based business. Data sharing can empower these parties to initialize and execute such collaboration, but conventional data sharing techniques are tedious and typically ineffective. These conventional data sharing techniques normally include manually evaluating updates provided by a party that is part of a particular supply chain for each collaborative party to determine what data should be shared with that collaborative party. However, even relatively small supply chains with a limited number of parties can produce a staggering number of updates, such that manual evaluation of data sharing rules for each party after each update becomes an incredibly time-intensive task. Moreover, performing such manual evaluation of data sharing rules for each individual shipment on each supply chain would further compound these inefficiencies.

These problems are even more acute given that not all parties that are part of a particular supply chain are intended to receive all updates or all portions of the updates. Shipments and other tracked activities as part of a supply chain may include thousands of updates for each individual activity, and each update may need to be shared among the supply chain parties in accordance with sharing rules. For example, a first party that is part of a first supply chain may only be allowed to receive shipment location updates without receiving specific data regarding other involved parties corresponding to the shipments. A second party that is part of a first supply chain may be allowed to receive shipment location updates as well as receiving specific data regarding the other involved parties corresponding to the shipments. Conventional techniques for evaluating sharing rules for each update occupy an immense amount of valuable processing resources and time, and produce inconsistent results. Consequently, conventional data sharing technologies suffer from several issues that minimize the capability to provide updates to supply chain participants in a manner that is efficient, accurate, and that simultaneously adheres to established sharing rules.

Thus, there is a need for technologies for dynamically filtering data fragments for sharing among recipient parties that enables a system to provide parties with logistics data in an efficient and consistent manner that adheres to established sharing rules.

### SUMMARY

As previously mentioned, conventional data sharing technologies suffer from a general lack of efficiency and accuracy. Many of these issues are the result of conventional technologies evaluating sharing rules relating to whether and how to share data with each party of the supply chain after receipt of each update. Conventional technologies may evaluate sharing rules for each party to determine (1) whether data is to be shared with the party and (2) what data is to be shared with the party. For example, conventional technologies may receive an update for a first shipment that includes multiple data fragments to be shared with multiple parties. The conventional technologies may evaluate the update to determine whether the update should be shared with any of the multiple parties, and thereafter evaluate which data fragments included in the update should be shared with each individual party. Evaluating whether the update should be shared with any of the multiple parties can consume significant processing resources, and this evaluation may be required thousands of times for each shipment or other activity that corresponds to a particular supply chain. Accordingly, conventional data sharing technologies occupy copious processing resources simply evaluating whether or not to share updates with parties.

Therefore, it is an objective of the present disclosure to eliminate these and other problems with conventional data sharing technologies by introducing a method for dynamically filtering data fragments for sharing among recipient parties that enables a system to evaluate sharing rules for a particular shipment or other shareable entities once; and as a result, substantially reduces the processing overhead required to share the shareable entity with multiple parties. Such efficient data sharing is achievable through the methods of the present disclosure via created rules that are configured to share data to desired entitled parties based on configurable criteria. As part of these configurable criteria, parties may desire to only share partial data, so the methods of the present disclosure enable customizable data filtering as an additional parameter on the created rules. In particular, the methods of the present disclosure alleviate the issues present with conventional technologies by determining that a set of data fragments is shared with a recipient party based on a core data entry, cloning a data fragment update to generate an identical data fragment, and filtering the identical data fragment according to filtering requirements of the sharing rule.

More broadly, the methods of the present disclosure may fragment incoming update data into separately managed fields, and then compile the update data back together. Each sharable entity (e.g., shipments) may have data separated into two fundamental parts: a core data entry and data fragments. The core data entry may be or include metadata used to determine which parties should be shared update data corresponding to the shareable entity (e.g., party identifiers, carrier information, shipment stop locations, etc.). The data fragments may be or include information corresponding to the shareable entity that is updated frequently (e.g., positions, events, attributes, etc.). These data fragments may be updated independently, but may still follow the sharing rules defined by the core data entry. This enables the methods of the present disclosure to only evaluate sharing rules once per shareable entity (e.g., when the core data entry is shared), and to scale the methods/systems to process a high frequency of updates without overburdening processing resources. For example, the methods and systems of the present disclosure enable easy, efficient support and information distribution for shipments that receive voluminous updates to each of the corresponding data fragments.

In accordance with the above, and with the disclosure herein, the present disclosure includes improvements in computer functionality or in improvements to other technologies at least because the present disclosure describes that, e.g., data sharing systems, and their related various components, may be improved or enhanced with the disclosed methods for dynamically filtering data fragments that provides more efficient data sharing for respective users. That is, the present disclosure describes improvements in the functioning of a data sharing system itself or “any other technology or technical field” (e.g., the field of shipping/data logistics) because the disclosed methods for dynamically filtering data fragments significantly improves and enhances operation of data sharing systems by introducing data fragmentation and configurable sharing rules that eliminate substantial processing inefficiencies typically experienced by data sharing systems lacking such methods. This improves over the prior art at least because such conventional data sharing systems are inefficient as they lack the ability to fragment data on configurable sharing rules in a manner that allows for efficient processing and distribution of update data for shareable entities.

In addition, the present disclosure includes applying various features and functionality, as described herein, with, or by use of, a particular machine, e.g., a central logistics server, a user device, a service provider device, and/or other hardware components as described herein.

Moreover, the present disclosure includes specific features other than what is well-understood, routine, conventional activity in the field, or adding unconventional steps that demonstrate, in various embodiments, particular useful applications, e.g., determining, by the one or more processors, to share the data fragment update with the recipient party without evaluating the sharing rule; cloning, by the one or more processors, the data fragment update to generate an identical data fragment update; and/or filtering, by the one or more processors, the identical data fragment update according to filtering requirements of the sharing rule associated with the recipient party.

In an embodiment, the present invention is a method for dynamically filtering data fragments for sharing among recipient parties. The method may comprise: receiving, at one or more processors, a data fragment update corresponding to a data fragment of a set of data fragments associated with a shareable entity, wherein the shareable entity includes a core data entry configured in accordance with a sharing rule; determining, by the one or more processors, to share the data fragment update with the recipient party without evaluating the sharing rule; cloning, by the one or more processors, the data fragment update to generate an identical data fragment update; filtering, by the one or more processors, the identical data fragment update according to a filtering requirement of the sharing rule associated with the recipient party; and sharing, by the one or more processors, the filtered identical data fragment update with the device associated with the recipient party.

In a variation of this embodiment, the method may further comprise: determining, at the one or more processors, the sharing rule corresponding to the recipient party based on inputs from a data originating party; creating, by the one or more processors, the core data entry; cloning, by the one or more processors, the core data entry to generate an identical core data entry; filtering, by the one or more processors, the identical core data entry according to the filtering requirement of the sharing rule; and sharing, by the one or more processors, the filtered identical core data entry with the device associated with the recipient party. Further in this variation, creating the core data entry further comprises: gathering, by the one or more processors executing a sharing rule engine, applicable sharing rules corresponding to the core data entry; and determining, by the one or more processors executing the sharing rule engine, whether a configuration of one or more of the applicable sharing rules matches the core data entry. Still further in this variation, the method further comprises: responsive to determining that the configuration of at least one of the applicable sharing rules matches the core data entry, creating, by the one or more processors, the core data entry that corresponds to the at least one of the applicable sharing rules.

In another variation of this embodiment, the recipient party is a plurality of recipient parties, and the sharing rule includes a respective filtering requirement corresponding to each of the plurality of recipient parties. Further in this variation, the recipient party is a first recipient party, the identical data fragment update is a first identical data fragment update, the filtering requirement is a first filtering requirement of the sharing rule, the filtered identical data fragment is a first filtered identical data fragment, the device associated with the first recipient party is a first device, and the method further comprises: determining, by the one or more processors, to share the data fragment update with the first recipient party and a second recipient party without evaluating the sharing rule; cloning, by the one or more processors, the data fragment update to generate a first identical data fragment update and a second identical data fragment update; filtering, by the one or more processors, (i) the first identical data fragment update according to the first filtering requirement of the sharing rule and (ii) the second identical data fragment update according to a second filtering requirement of the sharing rule; sharing, by the one or more processors, the filtered first identical data fragment update with the first device associated with the first recipient party; and sharing, by the one or more processors, the filtered second identical data fragment update with a second device associated with the second recipient party.

In yet another variation of this embodiment, the method may further comprise: sharing, by the one or more processors, the data fragment update with an originator device without evaluating the sharing rule.

In another embodiment, the present invention is a system for dynamically filtering data fragments for sharing among recipient parties. The system may comprise: a user interface; one or more processors; and one or more memories communicatively coupled with the user interface and the one or more processors, the one or more memories storing computer executable instructions thereon that, when executed by the one or more processors, cause the one or more processors to: receive a data fragment update corresponding to a data fragment of a set of data fragments associated with a shareable entity, wherein the shareable entity includes a core data entry configured in accordance with a sharing rule, determine to share the data fragment update with the recipient party without evaluating the sharing rule, clone the data fragment update to generate an identical data fragment update, filter the identical data fragment update according to a filtering requirement of the sharing rule associated with the recipient party, and share the filtered identical data fragment update with the device associated with the recipient party.

In a variation of this embodiment, the instructions, when executed, further cause the one or more processors to: determine the sharing rule corresponding to the recipient party based on inputs from a data originating party; create the core data entry; clone the core data entry to generate an identical core data entry; filter the identical core data entry according to the filtering requirement of the sharing rule; and share the filtered identical core data entry with the device associated with the recipient party. Further in this variation, the instructions, when executed, further cause the one or more processors to create the core data entry by: gathering, by executing a sharing rule engine, applicable sharing rules corresponding to the core data entry; and determining, by executing the sharing rule engine, whether a configuration of one or more of the applicable sharing rules matches the core data entry. Still further in this variation, the instructions, when executed, further cause the one or more processors to: responsive to determining that the configuration of at least one of the applicable sharing rules matches the core data entry, creating the core data entry that corresponds to the at least one of the applicable sharing rules.

In another variation of this embodiment, the recipient party is a plurality of recipient parties, and the sharing rule includes a respective filtering requirement corresponding to each of the plurality of recipient parties. Further in this variation, the recipient party is a first recipient party, the identical data fragment update is a first identical data fragment update, the filtering requirement is a first filtering requirement, the filtered identical data fragment is a first filtered identical data fragment, the device associated with the first recipient party is a first device, and the instructions, when executed, further cause the one or more processors to: determine to share the data fragment update with the first recipient party and a second recipient party without evaluating the sharing rule; clone the data fragment update to generate a first identical data fragment update and a second identical data fragment update; filter (i) the first identical data fragment update according to the first filtering requirement of the sharing rule and (ii) the second identical data fragment update according to a second filtering requirement of the sharing rule; share the filtered first identical data fragment update to the first device associated with the first recipient party; and share the filtered second identical data fragment update to a second device associated with the second recipient party.

In yet another variation of this embodiment, the instructions, when executed, further cause the one or more processors to: transmit the data fragment update to an originator device without evaluating the sharing rule.

In yet another embodiment, the present invention is a tangible machine-readable medium comprising instructions that, when executed by one or more processors, cause a machine to at least: receive a data fragment update corresponding to a data fragment of a set of data fragments associated with a shareable entity, wherein the shareable entity includes a core data entry configured in accordance with a sharing rule; determine to share the data fragment update with the recipient party without evaluating the haring rule; clone the data fragment update to generate an identical data fragment update; filter the identical data fragment update according to a filtering requirement of the sharing rule associated with the recipient party; and share the filtered identical data fragment update with the device associated with the recipient party.

In a variation of this embodiment, the instructions, when executed by the one or more processors, further cause the machine to at least: determine the sharing rule corresponding to the recipient party based on inputs from a data originating party; create the core data entry; clone the core data entry to generate an identical core data entry; filter the identical core data entry according to the filtering requirement of the sharing rule; and share the filtered identical core data entry with the device associated with the recipient party. Further in this variation, creating the core data entry further comprises: gathering, by executing a sharing rule engine, applicable sharing rules corresponding to the core data entry; and determining, by executing the sharing rule engine, whether or not a configuration of one or more of the applicable sharing rules matches the core data entry. Still further in this variation, the instructions, when executed by the one or more processors, further cause the machine to at least: responsive to determining that the configuration of at least one of the applicable sharing rules matches the core data entry, creating the core data entry that includes the at least one of the applicable sharing rules.

In another variation of this embodiment, the recipient party is a plurality of recipient parties, and the sharing rule includes a respective filtering requirement corresponding to each of the plurality of recipient parties. Further in this variation, the recipient party is a first recipient party, the identical data fragment update is a first identical data fragment update, the filtering requirement is a first filtering requirement, the filtered identical data fragment is a first filtered identical data fragment, the device associated with the first recipient party is a first device, and the instructions, when executed by the one or more processors, further cause the machine to at least: determine to share the data fragment update with the first recipient party and a second recipient party without evaluating the sharing rule; clone the data fragment update to generate a first identical data fragment update and a second identical data fragment update; filter (i) the first identical data fragment update according to the first filtering requirement of the sharing rule and (ii) the second identical data fragment update according to a second filtering requirement of the sharing rule; share the filtered first identical data fragment update with the first device associated with the first recipient party; and share the filtered second identical data fragment update with a second device associated with the second recipient party.originatororiginator

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example environment in which systems/devices for dynamically filtering data fragments for sharing among recipient parties may be implemented, in accordance with various embodiments described herein.

FIG. 2 depicts a collaborative visibility platform performing actions at multiple time instances 202a-b in accordance with instructions executed for dynamically filtering data fragments for sharing among recipient parties, and in accordance with embodiments described herein.

FIG. 3 depicts a shareable shipment with data fragments, which is an exemplary shareable entity, in accordance with various embodiments described herein.

FIG. 4 depicts an exemplary core entity processing workflow with a sharing rule engine, in accordance with various embodiments described herein.

FIG. 5 depicts an exemplary data fragment processing and sharing workflow, in accordance with various embodiments described herein.

FIG. 6 is a flowchart representative of a method for dynamically filtering data fragments for sharing among recipient parties, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

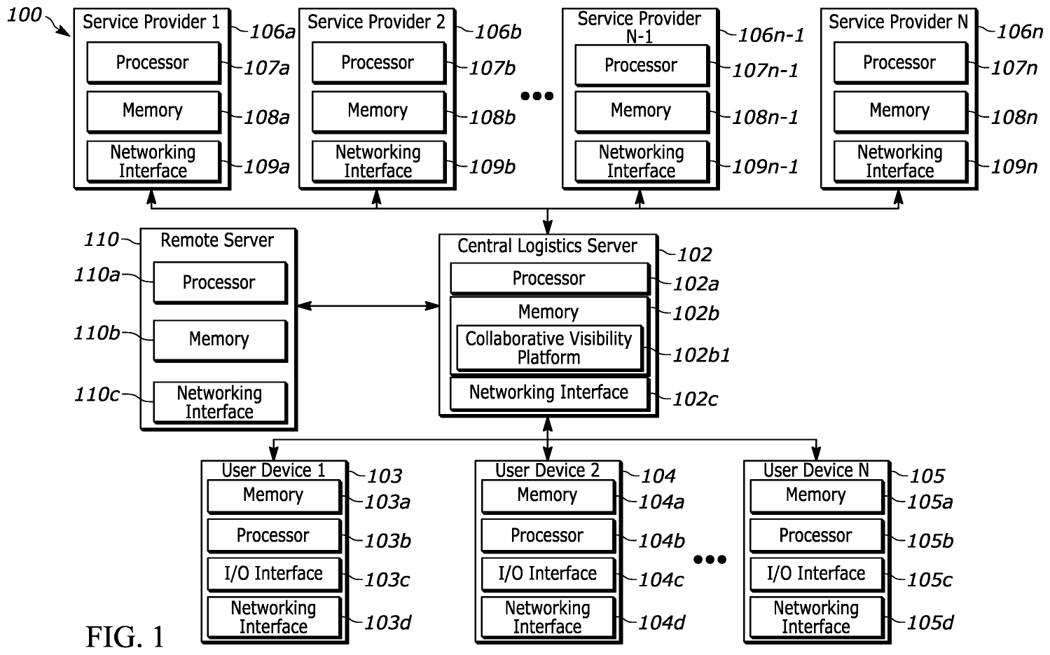

FIG. 1 depicts an example environment 100 in which systems/devices for dynamically filtering data fragments for sharing among recipient parties may be implemented, in accordance with various embodiments described herein. In the example embodiment of FIG. 1, the example environment 100 includes a central logistics server 102 that is communicatively coupled to a set of user devices 103, 104, 105, a set of service provider devices 106a-n, and a remote server 110. Generally speaking, the central logistics server 102, the set of user devices 103-105, the set of service provider devices 106a-n, and/or the remote server 110 may be capable of executing instructions to, for example, implement operations of the example methods described herein, as may be represented by the flowcharts of the drawings that accompany this description. Namely, the central logistics server 102 may be connected to the set of user devices 103-105, the set of service provider devices 106a-n, and/or the remote server 110 across multiple communication channels, and may generally be configured to receive and process information received from the set of user devices 103-105, the set of service provider devices 106a-n, and/or the remote server 110.

Generally speaking, the central logistics server 102 may be configured to transmit, receive, and filter data corresponding to shareable entities (e.g., shipments) in order to enable data sharing between/among the user devices 103-105. More specifically, the central logistics server 102 may be configured to receive a data fragment update (e.g., the set of service provider devices 106a-n), determine that data fragments included in the data fragment update should be shared with various users (also referenced herein as a “recipient party”), and clone and filter the data fragment update for various users. Thereafter, the central logistics server 102 may be configured to transmit the filtered data fragments to various users (e.g., the set of user devices 103-105) for display on the set of user device 103-105 (e.g., via I/O interfaces 103c, 104c, 105c).

The central logistics server 102 may also include a collaborative visibility platform 102b1 in the memory 102b that includes executable instructions that, when executed, may cause the central logistics server 102 to perform one or more of the actions described herein in reference to the methods of the present disclosure. More specifically, the collaborative visibility platform 102b1 may instruct the processor 102a to receive a data fragment update corresponding to a data fragment of a set of data fragments associated with a shareable entity, where the set of data fragments includes a core data entry that is stored on a device (e.g., the set of user devices 103-105) associated with a recipient party in accordance with a sharing rule, as described herein.

The collaborative visibility platform 102b1 may also include a sharing database (not shown) that corresponds to a set of sharing rules and/or filtering rules indicating which users should receive data updates and which data fragments of the data updates the users should receive. For example, the platform 102b1 may include a sharing database that includes sharing rules specifying that a first party, a second party, and a third party should receive data updates corresponding to a shareable entity. Further in this example, the sharing database may include filtering rules specifying that the first party should receive updates corresponding to a first data fragment and a second data fragment, but not a third data fragment. The filtering rules may further specify that a second party should receive updates corresponding to the second data fragment and the third data fragment, but not the first data fragment. Further, the filtering rules may specify that a third party should not receive updates corresponding to any of the first data fragment, the second data fragment, or the third data fragment.

The collaborative visibility platform 102b1 may further instruct the processor 102a to determine to share the data fragment update with the recipient party without evaluating the sharing rule. Namely, the platform 102b1 may include instructions that determine that data (e.g., core data entry) associated with a particular shareable entity has been shared with a set of users (e.g., set of users 103-105). Based on this determination, the collaborative visibility platform 102b1 may instruct the processor 102a to clone the data fragment update to generate an identical data fragment, and filter the identical data fragment according to filtering rules associated with the recipient parties.

In certain embodiments, the collaborative visibility platform 102b1 may create a piece of data (referenced herein as an “entitlement”) that indicates where the collaborative visibility platform 1021b should send data fragment updates based on where the core data fragment was shared. In particular, when a sharing rule matches the core data fragment, the collaborative visibility platform 102b1 may capture all the sharing rule data into an entitlement. The collaborative visibility platform 102b1 may then clone and share the identical data fragments with the recipient parties (e.g., set of users 103-105) in accordance with the same sharing rule indicated by the entitlement having a same identification number or string as the shareable entity. In this manner, the collaborative visibility platform 102b1 may transmit data fragments to the recipient parties by following the sharing rules indicated in the entitlement and without re-evaluating sharing rules at each receipt of a data fragment update.

The set of user devices 103-105 may be any suitable device that a user may use, for example, to execute an application and/or otherwise communicate with the central logistics server 102. In particular, the set of user devices 103-105 may be or include a mobile phone (e.g., a smartphone), a laptop, a tablet, a smartwatch, smart glasses, and/or any other suitable computing device or combinations thereof that is capable of communicating with the central logistics server 102. The set of user devices 103-105 each include a memory 103a, 104a, 105a, one or more processors 103b, 104b, 105b, an input/output (I/O) interface 103c, 104c, 105c, and a networking interface 103d, 104d, 105d. The memories 103a, 104a, 105a may include an application (not shown), which may generally include executable instructions, that when executed by the one or more processors 103b, 104b, 105b, cause the set of user devices 103-105 to perform various actions that enable a user of the user devices 103-105 to receive data fragment updates from the central logistics server 102 corresponding to a data fragment update.

Of course, it should be appreciated that the set of user devices 103-105 may correspond to any suitable number of user devices. For example, user device N 105 may represent a third user device, a fifth user device, a tenth user device, a one-hundredth user device, or any other suitable integer value user device that is communicatively connected to the central logistics server 102. Similarly, the set of service provider devices 106a-n may correspond to any suitable number of service provider devices. For example, service provider device N 106n may represent a fourth service provider device, a fifth service provider device, a tenth service provider device, a one-hundredth service provider device, or any other suitable integer value service provider device that is communicatively connected to the central logistics server 102.

In any event, the I/O interfaces 103c, 104c, 105c may include or implement operator interfaces configured to present information to an administrator, user, or operator and/or receive inputs from the administrator, user, or operator. An operator interface may provide a display screen (e.g., via the user devices 103-105) which a user/operator may use to visualize any images, graphics, text, data, features, pixels, and/or other suitable visualizations or information. For example, the set of user devices 103-105 may comprise, implement, have access to, render, or otherwise expose, at least in part, a graphical user interface (GUI) for displaying images, graphics, text, data, features, pixels, and/or other suitable visualizations or information on the display screen. The I/O interfaces 103c, 104c, 105c may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the set of user devices 103-105. According to some embodiments, an administrator or user/operator may access the set of user devices 103-105 to review shared data, make changes, input responses and/or selections, and/or perform other functions.

The set of service provider devices 106a-n may generally receive, store, and transmit information associated with services (e.g., individual shipments) performed by the individual service providers. Moreover, each service provider device 106a-n may correspond to a particular service provider, such that the shareable entity information received, stored, and/or transmitted at/from each device 106a-n may correspond to the specific service provider administering the device 106a-n. Each of the set of service provider devices 106a-n may include a processor 107a-n, a memory 108a-n, and a networking interface 109a-n.

For example, a first service provider may own and/or otherwise administer the service provider 1 device 106a, a second service provider may own and/or otherwise administer the service provider 2 device 106b, a third service provider may own and/or otherwise administer the service provider N−1 device 106n-1, and a fourth service provider may own and/or otherwise administer the service provider N device 106n. Consequently, the service provider 1 device 106a may receive, store, and/or transmit shipping information associated with shipments between various origins/destinations that were performed by the first service provider, the service provider 2 device 106b may receive, store, and/or transmit shipping information associated with shipments between various origins/destinations that were performed by the second service provider, the service provider N−1 device 106n-1 may receive, store, and/or transmit shipping information associated with shipments between various origins/destinations that were performed by the third service provider, and the service provider N device 106n may receive, store, and/or transmit shipping information associated with shipments between various origins/destinations that were performed by the fourth service provider.

Of course, the central logistics server 102 may be communicatively connected to any suitable number of service provider devices 106a-n, such that N/n may be any suitable number. Moreover, the set of service provider devices 106a-n may transmit received shareable entity data to the central logistics server 102 for processing/filtering. The central logistics server 102 may subsequently transmit the filtered shareable entity data to some/all of the connected user devices 103-105, as described herein.

The remote server 110 may generally be communicatively connected to the central logistics server 102, and may receive and/or transmit data from/to the central logistics server 102. The remote server 110 may also include a processor 110a, a memory 110b, and a networking interface 110c. For example, the central logistics server 102 may receive shareable entity data from the server 110 and may store the shareable entity data in memory 110b. As another example, the central logistics server 102 may transmit shareable entity data received/accessed from the set of service provider devices 106a-n to the remote server 110 for storage in the memory 110b. The remote server 110 may also be configured to execute instructions (via the processor 110a) to, for example, implement operations of the example methods described herein, as may be represented by the flowcharts of the drawings that accompany this description.

More generally, each of the one or more memories 102b, 103a, 104a, 105a, 108a-n, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., collaborative visibility platform 102b1 and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102a, 103b, 104b, 105b, 108a-n, 110a (e.g., working in connection with a respective operating system in the one or more memories 102b, 103a, 104a, 105a, 108a-n, 110b) to facilitate, implement, or perform the machine readable instructions, methods, processes, elements or limitations, as illustrated, depicted, or described for the various flowcharts, illustrations, diagrams, figures, and/or other disclosure herein.

The memories 102b, 103a, 104a, 105a, 108a-n, 110b may also store an operating system (OS) (e.g., Microsoft Windows, Linux, Unix, etc.) capable of facilitating the functionalities, apps, methods, or other software as discussed herein. Additionally, or alternatively, an application stored in memory 102b, 103a, 104a, 105a, 108a-n, 110b may also be stored in an external database (e.g., remote server 110), which is accessible or otherwise communicatively coupled to the central logistics server 102, the set of user devices 103-105, and/or the set of service provider devices 106a-n. For example, at least some of the applications, software components, or APIs may be, include, otherwise be part of, a particular application, where each may be configured to facilitate their various functionalities discussed herein. It should be appreciated that one or more other applications may be envisioned and that are executed by the one or more processors 102a, 103b, 104b, 105b, 108a-n, 110a.

In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.). Moreover, the one or more memories 102b, 103a, 104a, 105a, 108a-n, 110b may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102a, 103b, 104b, 105b, 108a-n, 110a may be connected to the one or more memories 102b, 103a, 104a, 105a, 108a-n, 110b via a computer bus responsible for transmitting electronic data, data packets, or otherwise electronic signals to and from the one or more processors 102a, 103b, 104b, 105b, 108a-n, 110a and one or more memories 102b, 103a, 104a, 105a, 108a-n, 110b in order to implement or perform the machine readable instructions, methods, processes, elements or limitations, as illustrated, depicted, or described for the various flowcharts, illustrations, diagrams, figures, and/or other disclosure herein.

The one or more processors 102a, 103b, 104b, 105b, 108a-n, 110a may interface with the one or more memories 102b, 103a, 104a, 105a, 108a-n, 110b via the computer bus to execute any suitable application (e.g., collaborative visibility platform 102b1), algorithm, and/or executable instructions necessary to perform any of the actions associated with the methods of the present disclosure. The one or more processors 102a, 103b, 104b, 105b, 108a-n, 110a may also interface with the one or more memories 102b, 103a, 104a, 105a, 108a-n, 110b via the computer bus to create, read, update, delete, or otherwise access or interact with the data stored in the one or more memories 102b, 103a, 104a, 105a, 108a-n, 110b and/or external databases (e.g., a relational database, such as Oracle, DB2, MySQL, or a NoSQL based database, such as MongoDB). The data stored in the one or more memories 102b, 103a, 104a, 105a, 108a-n, 110b and/or an external database may include all or part of any of the data or information described herein, including, for example, shareable entity data, data fragments, shipping information, shipping metrics, origin data, destination data, origin/destination tile data, and/or other suitable information or combinations thereof.

The networking interfaces 102c, 104d, 109a-n, 110c may be configured to communicate (e.g., send and receive) data via one or more external/network port(s) to one or more networks or local terminals, as described herein. In some embodiments, the networking interfaces 102c, 104d, 109a-n, 110c may include a client-server platform technology such as ASP.NET, Java J2EE, Ruby on Rails, Node.js, a web service or online API, responsive for receiving and responding to electronic requests. The networking interfaces 102c, 103d, 104d, 105d, 109a-n, 110c may implement the client-server platform technology that may interact, via the computer bus, with the one or more memories 102b, 103a, 104a, 105a, 108a-n, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 102c, 103d, 104d, 105d, 109a-n, 110c may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating to central logistics server 102 (via the networking interface 102c), the set of user devices 103-105 (via networking interfaces 103d, 104d, 105d), the set of service provider devices 106a-n (via the networking interfaces 109a-n), and/or the remote server 110 (via networking interface 110c) via wireless communications based on any one or more of various wireless standards, including by non-limiting example, the BLUETOOTH standard (e.g., BLE), IEEE 802.11a/b/c/g (WIFI), or the like.

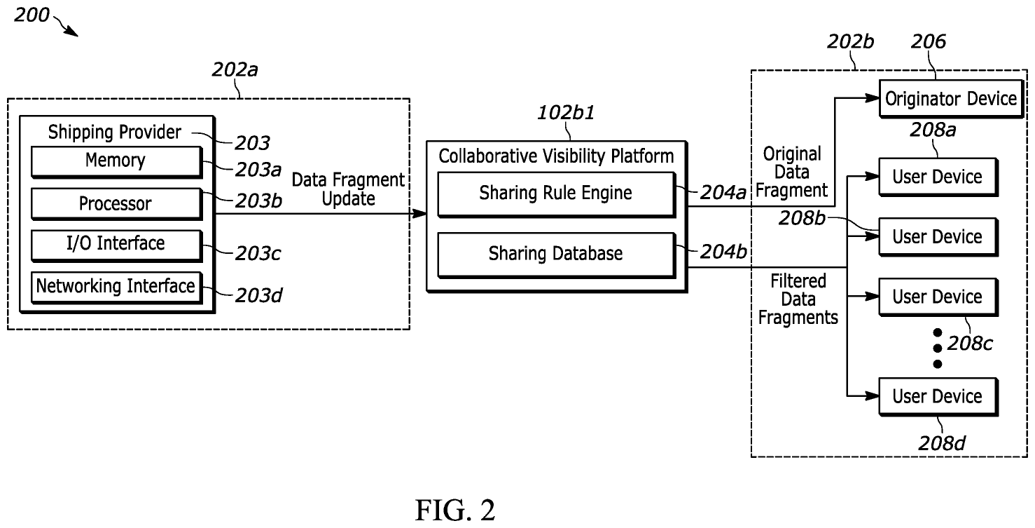

FIG. 2 depicts a collaborative visibility platform 102b1 performing actions at multiple time instances 202a-b in accordance with instructions executed for dynamically filtering data fragments for sharing among recipient parties, and in accordance with embodiments described herein. Generally speaking, the collaborative visibility platform 102b1 may receive inputs (e.g., a data fragment update) from a shipping provider device 203 at a first time instance 202a, and the platform 102b1 may output original data fragments and filtered data fragments to an originator device 206 and user devices 208a-d at a second time instance 202b. Of course, the shipping provider device 203 is described herein as referencing a device owned by a shipping provider for the purposes of discussion only, and it should be understood that the device 203 may be owned and/or otherwise represent any suitable type of service provider. Further, as described herein, an “originator” may be or include a user that has unfiltered access to updates of a particular shareable entity (e.g., the original data fragment), such as a shipment, and “non-originators” may be or include a user that may receive filtered versions of updates (e.g., filtered data fragments). In other words, the originator device 206 may receive data updates prior to applying any sharing rules.

More specifically, at the first time instance 202a, the collaborative visibility platform 102b1 may receive a data fragment update from an electronic device associated with a service provider (e.g., shipping provider device 203). The users of the user devices 208a-d and originator device 206 may desire to receive updates to services provided by the service provider on their behalf. For example, the shipping provider 203 may ship goods owned by the user of the originator device 206 to each of the users of the user devices 208a-d. The shipping provider 203 may receive an update corresponding to a shareable entity that involves each of the originator and users of the originator device 206 and the user devices 208a-d. The shipping provider 203 may then transmit a data fragment update that includes the update to the collaborative visibility platform 102b1. The data fragment update may, for example, include updates to a location of a shipment, a current delivery, an event related to the shipment, and/or any other suitable update corresponding to the shipment.

More specifically, the data fragment update may correspond to a first data fragment of a set of data fragments that are associated with a shareable entity (e.g., a shipment). The set of data fragments may include a core data entry that is stored on a device associated with a recipient party (e.g., originator device 206, user devices 208a-d), and the core data entry may include metadata corresponding to sharing rules that enables the processor 102a (e.g., via the collaborative visibility platform 102b1 or, more specifically, the sharing rule engine 204a) to determine other recipient parties for data fragments of the shareable entity. For example, the sharing rules defined by the metadata of the core data entry may specify that the originator device 206 and each of the user devices 208a-d may receive data fragment updates corresponding to a particular shareable entity.

Each of the sharing rules that may be applied to any user may be stored and/or otherwise located in the sharing rules database 204b. For example, the sharing engine 204a may instruct the processor 102a to access the sharing database 204b to retrieve/access filtering requirements specifying that an originator user may receive all data updates without any filtering applied (e.g., the original data fragment), and that non-originator users may receive data updates that are filtered to varying degrees (e.g., the filtered data fragments). Each non-originator may have specific filtering requirements that are applied for each update, but non-originators may share or otherwise have similar/identical filters applied to each update. The sharing rule engine 204a may retrieve and/or check the rules included in the sharing database 204b to evaluate how the data fragment update should be filtered for each user that has a copy of the core data entry. However, more broadly, the sharing database 204b may serve as a storage location for the filtering requirements included as part of the sharing rule(s) used to filter the received data fragment updates for shareable entities. The collaborative visibility platform 102b1 may designate specific locations within the sharing database 204b for each shareable entity (e.g., individual shipments), and may subdivide those specific locations into various categories for the sharing rules of the core data entry. Moreover, the various data fragments/updates themselves may also be stored separately in specific locations within the sharing database 204b, and may be reassembled as necessary when sharing data corresponding with the shareable entity with recipient parties.

In particular, when the collaborative visibility platform 102b1 receives the data fragment update, the sharing rule engine 204a may determine to share the data fragment update with the recipient party without evaluating the sharing rules. Namely, the sharing rule engine 204a may simply interpret the entitlement corresponding to the core data entry stored in the sharing database 204b and/or otherwise stored in the central server 102 to determine that the data fragment update should be shared with the recipient party. The sharing rules are previously defined as part of creating the core data entry, such that the sharing rules may not need to be re-evaluated for legitimacy/validity during each receipt of data fragment updates. In this manner, the sharing rules may only be evaluated once at the creation of the core data entry, and only the filtering rules may be evaluated during subsequent receipt of data fragment updates to determine what (instead of whether) data is to be shared with recipient parties. Of course, in certain circumstances, the sharing rules may also be evaluated when the collaborative visibility platform 102b1 receives an update to the core data entry. Further, the collaborative visibility platform 102b1 may also clone/filter/share any fragment updates corresponding to the core data entry according to the associated sharing rule(s).

In certain embodiments, the sharing rule engine 204a may locate the core data entry within the sharing database 204b and interpret the metadata included as part of the core data entry. The entitlement sharing rule engine 204a may then clone, by executing a position cloner, the data fragment update to generate an identical data fragment. For example, the sharing rule engine 204a may determine that the data fragment update corresponds to a location update and an estimated delivery date update for the shareable entity (e.g., a shipment, in this instance). The sharing rule engine 204a may clone the update for each recipient party indicated in the core data entry metadata to which the data fragments are shared. In this example, the sharing rule engine 204a may determine that four non-originator users (e.g., corresponding to user devices 208a-d) are configured to receive data updates corresponding to the shareable entity.

The sharing rule engine 204a may then retrieve and/or otherwise receive filtering rules from the sharing database 204b to determine what data fragments of the data fragment update should be shared with each recipient party. More specifically, the sharing rule engine 204a may filter the cloned/identical data fragment updates according to the filtering rules associated with each respective recipient party. Continuing the prior example, three of the non-originator users (e.g., users 1-3) may be specifically configured to receive location updates under the filtering rules, and two of the non-originator users (e.g., users 3, 4) may be specifically configured to receive estimated delivery date updates under the filtering rules. Accordingly, the sharing rule engine 204a may filter the identical updates for each user, such that only users 1-3 each receive the location update, and only users 3 and 4 each receive the estimated delivery date update. Of course, this example is for the purposes of discussion only, and the data fragment update may include any suitable data corresponding to a shareable entity, and that data may be filtered in any suitable manner based on the filtering rules included in the sharing database 204b.

The collaborative visibility platform 102b1 may then transmit the filtered identical data fragment updates to the devices associated with the recipient parties. In particular, as illustrated at the second time instance 202b, when the sharing rule engine 204a instructs the processors 102a to filter the data fragments in accordance with the filtering rules, the engine 204a may further instruct the processors 102a to transmit the filtered data fragments to each of the user devices 208a-d associated with the recipient parties. The sharing rule engine 204a may also instruct the processors 102a to transmit the original data fragment update to the originator device 206 associated with the originator party. In this manner, the originator party may receive the unfiltered data fragments, and the other recipient parties may receive filtered data fragments that are filtered in accordance with filtering rules stored in the sharing database 204b.

In certain embodiments, the collaborative visibility platform 102b1 may determine the sharing rule(s) and/or the filtering rule(s) corresponding to the recipient party based on inputs from the data originating party (e.g., originator device 206). For example, the originating party may input (e.g., via the originator device 206) information corresponding to each of the one or more recipient parties (e.g., user devices 208a-d), and this information may be stored and/or otherwise interpreted by the collaborative visibility platform 102b1. The sharing rule engine 204a may include instructions that cause the processors 102a to search, query, and/or otherwise interact with the sharing database 204b to determine sharing rules and/or filtering rules for cloning, filtering, and transmitting data fragment updates to the recipient parties.

Namely, the sharing rule engine 204a may utilize the information provided by the originating party to create the metadata of the core data entry that includes and/or otherwise represents the sharing rule(s). In particular, the sharing rule engine 204a may gather applicable sharing rules from the sharing database 204b corresponding to the core data entry. The sharing rule engine 204a may then determine whether or not a configuration of one or more of the applicable sharing rules matches information (e.g., metadata) included in the core data entry. Responsive to determining that the configuration of at least one of the applicable sharing rules matches the information of the core data entry, the sharing rule engine 204a may create the entitlement(s) in accordance with at least one of the applicable sharing rules.

For example, the sharing rule engine 204a may identify a first sharing rule that matches a first shipment (e.g., shipment number 123), and will create a first entitlement for the first shipment associated with the first sharing rule. In this example, the sharing rule engine 204a may identify that the first sharing rule also matches a second shipment (e.g., shipment number 456), and may create a second entitlement for the second shipment associated with the first sharing rule. The first entitlement may be associated with the same sharing rule as the second entitlement, but the first/second entitlements may instruct the collaborative visibility platform 102b1 to clone/filter/share data fragment updates of the first/second shipments.

In some embodiments, and as illustrated in FIG. 2, the recipient party may be a plurality of recipient parties, and the at least one filtering rule may include a respective filtering rule corresponding to each of the plurality of recipient parties. For example, the recipient party may be a first recipient party, the identical data fragment update may be a first identical data fragment update, the filtering rule may be a first filtering rule, the filtered identical data fragment may be a first filtered identical data fragment, and the device associated with the first recipient party may be a first device. In this example, the processors 102a may determine to share the data fragment update with the first recipient party and a second recipient party without evaluating the sharing rule.

Continuing this example, the processors 102a may also clone the data fragment update to generate a first identical data fragment update and a second identical data fragment update. The processors 102a may then filter (i) the first identical data fragment update according to the first filtering rule and (ii) the second identical data fragment update according to a second filtering rule. As a result, the first identical data fragment update may include a different subset of the data from the data fragment update than the second identical data fragment. The data fragment update may include a location update and an event update, the first identical data fragment may include the location update, and the second identical data fragment may include the event update. In any event, the processors 102a may then transmit the filtered first identical data fragment update to the first device (e.g., user device 208a) associated with the first recipient party, and transmit the filtered second identical data fragment update to a second device (e.g., user device 208b) associated with the second recipient party.

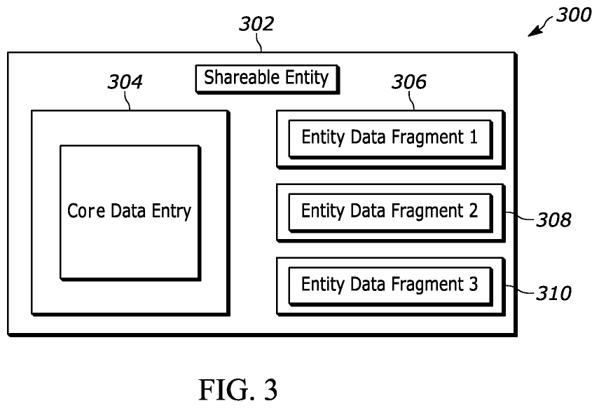

FIG. 3 depicts a shareable shipment 300 with data fragments, which is an exemplary shareable entity 302, in accordance with various embodiments described herein. Generally, the exemplary shareable entity 302 includes a core data entry 304, a first entity data fragment 306, a second entity data fragment 308, and a third entity data fragment 310. As previously mentioned, the core data entry 304 may generally include all information necessary to determine which parties to share data fragment updates with in a manner that avoids evaluating sharing rules in response to receiving each data fragment update. For example, the core data entry 304 may include shipment metadata corresponding to shipment identifiers for the shipment, carrier information for carriers transporting the shipment, relevant stops of the shipment during transit, and/or any other suitable information corresponding to the shipment or combinations thereof. Of course, it should be appreciated that the core data entry 304 illustrated in FIG. 3 is for the purposes of discussion only, and that a shareable entity 302 may include any suitable metadata within the core data entry 304 that corresponds to any suitable type or quantity of data associated with the shareable entity 302.

As mentioned, creating the core data entry 304 enables sharing of the data fragment updates to recipient parties. The sharing rule engine (e.g., sharing rule engine 204a) may generally process the core data entry 304 before creation. Namely, the sharing rule engine may gather any potentially applicable sharing rules from the sharing database (e.g., sharing database 204b), and may determine if any of the configurations of these potentially applicable sharing rules match the core data entry 304 of the exemplary shareable entity 302.

For example, the sharing rule engine may determine that a first sharing rule specifying that a first data fragment category is shared with recipient parties does not match the core data entry 304 if the first data fragment category is not included in the core data entry 304. Of course, it will be appreciated that received data fragment updates may always correspond to at least one core data entry. For example, a data fragment update representing a position update for a first shipment may correspond to a single shipment (e.g., a core data entry). Thus, it should be understood that the sharing rule engine may generally apply a broad sharing rule that shares data fragment updates with certain recipient parties if the corresponding core data entry is also shared with those certain recipient parties.

Regardless, if any of the potentially applicable rules have a configuration that matches and/or otherwise aligns with the core data entry, then the processors (e.g., processors 102a) may subsequently clone the core data entry 304 for each entitled/recipient party based on the applicable rule(s). The processors 102a may also filter the cloned core data entry 304 according to filtering rules that may also be identified and/or otherwise specified as part of the matching applicable rule(s) retrieved from the sharing database 204b.

The entity data fragments 306, 308, 310 may generally correspond to particular categories of data that are associated with the exemplary shareable entity 302 and that may be shared to recipient parties. For example, the first entity data fragment 306 may correspond to position/location updates for the exemplary shareable entity 302. The second entity data fragment 308 may correspond to event updates for the exemplary shareable entity 302. The third entity data fragment 310 may correspond to attribute updates for the exemplary shareable entity 302. Of course, it should be appreciated that the data fragments 306, 308, 310 illustrated in FIG. 3 are for the purposes of discussion only, and that a shareable entity 302 may include any suitable number of data fragments 306, 308, 310 that correspond to any suitable type or quantity of data fragments.

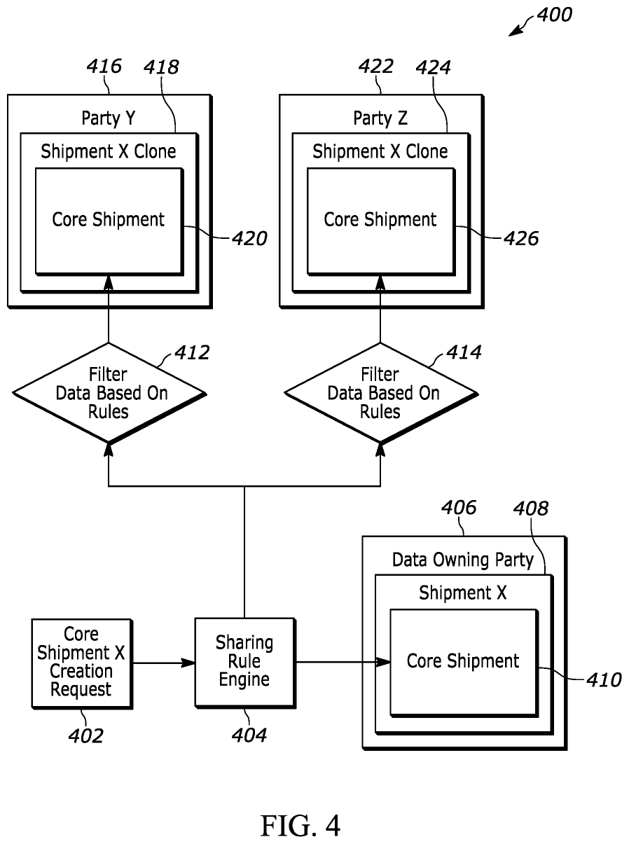

FIG. 4 depicts an exemplary core entity processing workflow 400 with a sharing rule engine 404, in accordance with various embodiments described herein. Generally, the exemplary core entity processing workflow 400 may illustrate the cloning, filtering, and sharing/transmission of the core data entry (e.g., core data entry 304) with recipient parties (e.g., party Y 416, party Z 422). When the core data entry is created, cloned, filtered, and shared, the systems of the present disclosure (e.g., example environment 100) may process (e.g., evaluate, clone, filter, share, etc.) any data fragment updates that correspond to the core data entry in accordance with the same sharing/filtering rules without re-evaluating the sharing rules upon receipt of every data fragment update. As a result, the exemplary core entity processing workflow 400 helps enable minimizing data fragment update payload sizes, and dramatically improves processing efficiency by only evaluating the sharing rules once to update the necessary data fragments.

As illustrated in FIG. 4, the exemplary core entity processing workflow 400 may include a core data entry creation request 402, which may be received by the sharing rule engine 404. The core data entry creation request 402 may be input by a user (e.g., originator user through originator device 206), and may include instructions that cause the sharing rule engine 404 to clone and/or otherwise store the core data entry 410 into the originating party's device 406. In particular, the core data entry 410 may be stored in a shareable entity storage location 408 in memory of the originating party's device 406.

When the core data entry 410 is stored in the originating party's device 406, the sharing rule engine 404 may proceed to filter two cloned versions of the core data entry 410 and transmit them to the other recipient parties (e.g., non-originator parties Y and Z 416, 422). For example, at block 412, the sharing rule engine 404 may filter a first clone 420 of the core data entry 410 using a first filtering rule that corresponds to recipient party Y 416. Similarly, at block 414, the sharing rule engine 404 may filter a second clone 426 of the core data entry 410 using a second filtering rule that corresponds to recipient party Z 422. The first filtering rule may be similar, identical, or different from the second filtering rule, such that the core data entry 420 may be similar, identical, or different from the core data entry 426.

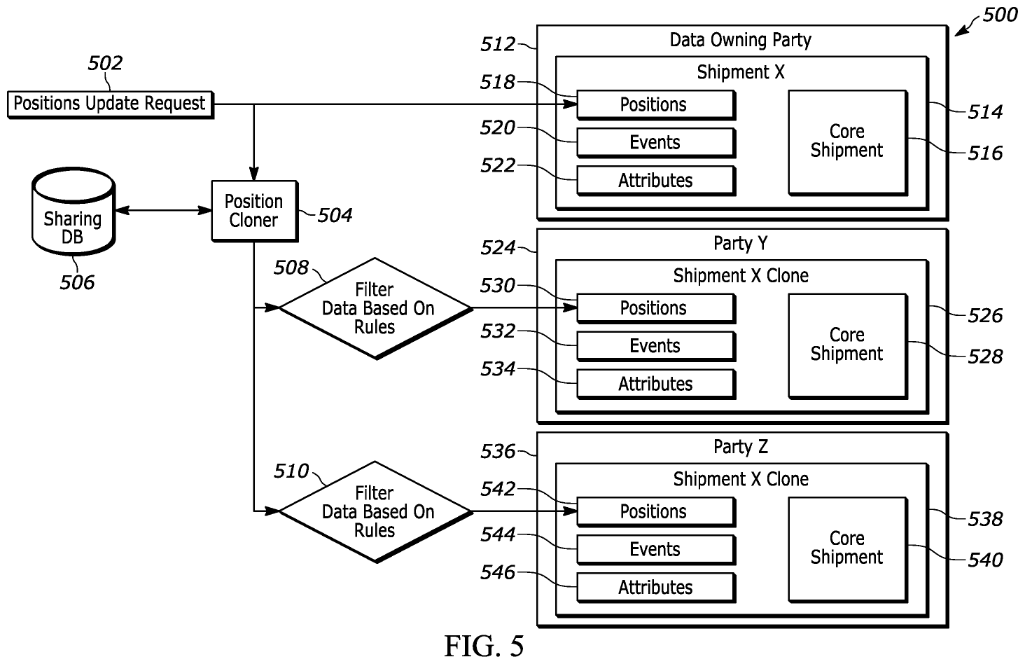

The sharing rule engine 404 may then transmit the first clone 420 of the core data entry 410 to the recipient party Y device 416 for storage in the shareable entity clone location 418. The sharing rule engine 404 may also transmit the second clone 426 to the recipient party Z device 422 for storage in the shareable entity clone location 424. In this way, both the party Y device 416 and the party Z device 422 may include the relevant data of the core data entry 410 required to share data fragment updates with the respective devices 416, 422. More specifically, using the first clone 420 and the second clone 426, the sharing engine 404 may proceed to filter and share data fragment updates with the party Y device 416 and the party Z device 422 based on the data included in the clones 420, 426 of the core data entry 410. This filtering and sharing process of data fragment updates is illustrated in FIG. 5.

FIG. 5 depicts an exemplary data fragment processing and sharing workflow 500, in accordance with various embodiments described herein. Generally speaking, upon receipt of each data fragment update, the metadata contained in the core data entry and the data fragments update is gathered and searched to determine what data is to be shared with each recipient entity. As an example embodiment, the exemplary data fragment processing and sharing workflow 500 may include publishing the metadata from the core data entry as a message to a Kafka topic, causing a gathering service to gather the metadata (e.g., sharing rules, entitlements), and storing them into Elasticsearch (e.g., sharing database 506) where the metadata may be easily searchable for analysis.

In particular, at block 502, the workflow 500 may include receiving a data fragment update. As an example, the data fragment update may be a position update. The data fragment update may be transmitted directly to the originator device 512, and stored in the shareable entity storage location 514. Further in the example, the data fragment update may be stored in the shareable entity storage location 514 in a position data fragment storage location 518. The shareable entity storage location 514 may also include a core data entry 516, an event data fragment storage location 520, and an attribute data fragment storage location 522.

When the data fragment update is successfully stored in the originator device 512, the processors 102a may utilize a position cloner 504 to clone the data fragment update for transmission to the recipient party devices 524, 536. However, as part of cloning and transmitting the data fragment update, the processors 102a may access the sharing database 506 to retrieve and/or otherwise analyze the filtering rules to filter the cloned data fragment updates for transmission to the recipient party devices 524, 536. Thus, the position cloner 504 may clone the data fragment update, and the processors 102a may then filter the cloned data fragment updates at block 508 and block 510 in accordance with the filtering rules obtained from the sharing database 506. In certain embodiments, the sharing database 506 may also include sharing/filtering rules that correspond to regional policies that may enable/prohibit data sharing of various types to recipient parties in certain situations.

In any event, when the data fragment update is cloned and filtered, the data fragment updates may be transmitted to and stored in the respective recipient party devices 524, 536. A first cloned/filtered data fragment update may be transmitted to the party Y device 524, and stored in a first cloned/filtered shareable entity storage location 526. For example, the first cloned/filtered data fragment update may be stored in the first cloned/filtered shareable entity storage location 526 in a position data fragment storage location 530. The first cloned/filtered shareable entity storage location 526 may also include a first cloned/filtered core data entry 528, an event data fragment storage location 532, and an attribute data fragment storage location 534.

A second cloned/filtered data fragment update may be transmitted to the party Z device 536, and stored in a second cloned/filtered shareable entity storage location 538. For example, the second cloned/filtered data fragment update may be stored in the second cloned/filtered shareable entity storage location 538 in a position data fragment storage location 542. The second cloned/filtered shareable entity storage location 538 may also include a second cloned/filtered core data entry 540, an event data fragment storage location 544, and an attribute data fragment storage location 546.

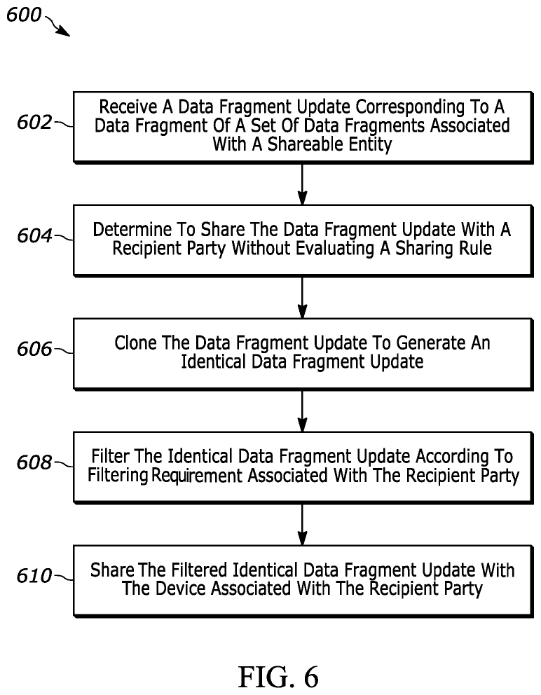

FIG. 6 is a flowchart representative of a method 600 for dynamically filtering data fragments for sharing among recipient parties, in accordance with embodiments described herein. Generally, and as described herein, the method 600 for dynamically filtering data fragments for sharing among recipient parties may include the central logistics server 102 receiving a data fragment update, determining that a set of data fragments is shared with a recipient party, cloning the data fragment update to generate an identical data fragment, filtering the identical data fragment, and transmitting the filtered identical data fragment to a device associated with the recipient party. More specifically, the method 600 may enable the central logistics server 102 to efficiently share data updates to users based on sharing/filtering rules. It is to be understood that any of the steps of the method 600 may be performed by, for example, the central logistics server 102, and/or any other suitable components or combinations thereof discussed herein.

At block 602, the method 600 may include receiving, at one or more processors, a data fragment update corresponding to a data fragment of a set of data fragments associated with a shareable entity, wherein the shareable entity includes a core data entry configured in accordance with a sharing rule. At block 604, the method 600 may further include determining, by the one or more processors, to share the data fragment update with the recipient party without evaluating the sharing rule. At block 606, the method 600 may include cloning, by the one or more processors, the data fragment update to generate an identical data fragment update.

At block 608, the method 600 may further include filtering, by the one or more processors, the identical data fragment update according to a filtering requirement of the sharing rule associated with the recipient party. At block 610, the method 600 may further include sharing, by the one or more processors, the filtered identical data fragment update with the device associated with the recipient party.

In some embodiments, the method 600 may further comprise: determining, at the one or more processors, the sharing rule corresponding to the recipient party based on inputs from a data originating party; creating, by the one or more processors, the core data entry; cloning, by the one or more processors, the core data entry to generate an identical core data entry; filtering, by the one or more processors, the identical core data entry according to the filtering requirement of the sharing rule; and sharing, by the one or more processors, the filtered identical core data entry with the device associated with the recipient party. Further in these embodiments, creating the core data entry further comprises: gathering, by the one or more processors executing a sharing rule engine, applicable sharing rules corresponding to the core data entry; and determining, by the one or more processors executing the sharing rule engine, whether a configuration of one or more of the applicable sharing rules matches the core data entry. Still further in these embodiments, the method 600 may further comprise: responsive to determining that the configuration of at least one of the applicable sharing rules matches the core data entry, creating, by the one or more processors, the core data entry that corresponds to the at least one of the applicable sharing rules.

In certain embodiments, the recipient party is a plurality of recipient parties, and the sharing rule includes a respective filtering requirement corresponding to each of the plurality of recipient parties. Further in these embodiments, the recipient party is a first recipient party, the identical data fragment update is a first identical data fragment update, the filtering requirement is a first filtering requirement of the sharing rule, the filtered identical data fragment is a first filtered identical data fragment, the device associated with the first recipient party is a first device, and the method 600 may further include: determining, by the one or more processors, to share the data fragment update with the first recipient party and a second recipient party without evaluating the sharing rule; cloning, by the one or more processors, the data fragment update to generate a first identical data fragment update and a second identical data fragment update; filtering, by the one or more processors, (i) the first identical data fragment update according to the first filtering requirement of the sharing rule and (ii) the second identical data fragment update according to a second filtering requirement of the sharing rule; sharing, by the one or more processors, the filtered first identical data fragment update with the first device associated with the first recipient party; and sharing, by the one or more processors, the filtered second identical data fragment update with a second device associated with the second recipient party.

In some embodiments, the method 600 may further include: sharing, by the one or more processors, the data fragment update with an originator device without evaluating the sharing rule.

Of course, it is to be appreciated that the actions of the method 600 may be performed in any suitable order and any suitable number of times.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for dynamically filtering data fragments for sharing among recipient parties, the method comprising:
receiving, at one or more processors, a data fragment update corresponding to a data fragment of a set of data fragments associated with a shareable entity, wherein the shareable entity includes a core data entry configured in accordance with a sharing rule;
determining, by the one or more processors, to share the data fragment update with the recipient party without evaluating the sharing rule;
cloning, by the one or more processors, the data fragment update to generate an identical data fragment update;
filtering, by the one or more processors, the identical data fragment update according to a filtering requirement of the sharing rule associated with the recipient party; and
sharing, by the one or more processors, the filtered identical data fragment update with the device associated with the recipient party.

2. The method of claim 1, further comprising:
determining, at the one or more processors, the sharing rule corresponding to the recipient party based on inputs from a data originating party;
creating, by the one or more processors, the core data entry;
cloning, by the one or more processors, the core data entry to generate an identical core data entry;
filtering, by the one or more processors, the identical core data entry according to the filtering requirement of the sharing rule; and
sharing, by the one or more processors, the filtered identical core data entry with the device associated with the recipient party.

3. The method of claim 2, wherein creating the core data entry further comprises:
gathering, by the one or more processors executing a sharing rule engine, applicable sharing rules corresponding to the core data entry; and
determining, by the one or more processors executing the sharing rule engine, whether a configuration of one or more of the applicable sharing rules matches the core data entry.

4. The method of claim 3, further comprising:
responsive to determining that the configuration of at least one of the applicable sharing rules matches the core data entry, creating, by the one or more processors, the core data entry that corresponds to the at least one of the applicable sharing rules.

5. The method of claim 1, wherein the recipient party is a plurality of recipient parties, and the sharing rule includes a respective filtering requirement corresponding to each of the plurality of recipient parties.

6. The method of claim 5, wherein the recipient party is a first recipient party, the identical data fragment update is a first identical data fragment update, the filtering requirement is a first filtering requirement of the sharing rule, the filtered identical data fragment is a first filtered identical data fragment, the device associated with the first recipient party is a first device, and the method further comprises:
determining, by the one or more processors, to share the data fragment update with the first recipient party and a second recipient party without evaluating the sharing rule;
cloning, by the one or more processors, the data fragment update to generate a first identical data fragment update and a second identical data fragment update;
filtering, by the one or more processors, (i) the first identical data fragment update according to the first filtering requirement of the sharing rule and (ii) the second identical data fragment update according to a second filtering requirement of the sharing rule;
sharing, by the one or more processors, the filtered first identical data fragment update with the first device associated with the first recipient party; and
sharing, by the one or more processors, the filtered second identical data fragment update with a second device associated with the second recipient party.

7. The method of claim 1, further comprising:
sharing, by the one or more processors, the data fragment update with an originator device without evaluating the sharing rule.

8. A system for dynamically filtering data fragments for sharing among recipient parties, the system comprising:
a user interface;
one or more processors; and
one or more memories communicatively coupled with the user interface and the one or more processors, the one or more memories storing computer executable instructions thereon that, when executed by the one or more processors, cause the one or more processors to:
receive a data fragment update corresponding to a data fragment of a set of data fragments associated with a shareable entity, wherein the shareable entity includes a core data entry configured in accordance with a sharing rule,
determine to share the data fragment update with the recipient party without evaluating the sharing rule,
clone the data fragment update to generate an identical data fragment update,
filter the identical data fragment update according to a filtering requirement of the sharing rule associated with the recipient party, and
share the filtered identical data fragment update with the device associated with the recipient party.

9. The system of claim 8, wherein the instructions, when executed, further cause the one or more processors to:
determine the sharing rule corresponding to the recipient party based on inputs from a data originating party;
create the core data entry;
clone the core data entry to generate an identical core data entry;
filter the identical core data entry according to the filtering requirement of the sharing rule; and
share the filtered identical core data entry with the device associated with the recipient party.

10. The system of claim 9, wherein the instructions, when executed, further cause the one or more processors to create the core data entry by:
gathering, by executing a sharing rule engine, applicable sharing rules corresponding to the core data entry; and
determining, by executing the sharing rule engine, whether a configuration of one or more of the applicable sharing rules matches the core data entry.

11. The system of claim 10, wherein the instructions, when executed, further cause the one or more processors to:
responsive to determining that the configuration of at least one of the applicable sharing rules matches the core data entry, creating the core data entry that corresponds to the at least one of the applicable sharing rules.

12. The system of claim 8, wherein the recipient party is a plurality of recipient parties, and the sharing rule includes a respective filtering requirement corresponding to each of the plurality of recipient parties.

13. The system of claim 12, wherein the recipient party is a first recipient party, the identical data fragment update is a first identical data fragment update, the filtering requirement is a first filtering requirement, the filtered identical data fragment is a first filtered identical data fragment, the device associated with the first recipient party is a first device, and the instructions, when executed, further cause the one or more processors to:
determine to share the data fragment update with the first recipient party and a second recipient party without evaluating the sharing rule;
clone the data fragment update to generate a first identical data fragment update and a second identical data fragment update;
filter (i) the first identical data fragment update according to the first filtering requirement of the sharing rule and (ii) the second identical data fragment update according to a second filtering requirement of the sharing rule;
share the filtered first identical data fragment update to the first device associated with the first recipient party; and
share the filtered second identical data fragment update to a second device associated with the second recipient party.

14. The system of claim 8, wherein the instructions, when executed, further cause the one or more processors to:
transmit the data fragment update to an originator device without evaluating the sharing rule.

15. A tangible machine-readable medium comprising instructions that, when executed by one or more processors, cause a machine to at least:
receive a data fragment update corresponding to a data fragment of a set of data fragments associated with a shareable entity, wherein the shareable entity includes a core data entry configured in accordance with a sharing rule;
determine to share the data fragment update with the recipient party without evaluating the sharing rule;
clone the data fragment update to generate an identical data fragment update;
filter the identical data fragment update according to a filtering requirement of the sharing rule associated with the recipient party; and
share the filtered identical data fragment update with the device associated with the recipient party.

16. The tangible machine-readable medium of claim 15, wherein the instructions, when executed by the one or more processors, further cause the machine to at least:
determine the sharing rule corresponding to the recipient party based on inputs from a data originating party;
create the core data entry;
clone the core data entry to generate an identical core data entry;
filter the identical core data entry according to the filtering requirement of the sharing rule; and
share the filtered identical core data entry with the device associated with the recipient party.

17. The tangible machine-readable medium of claim 16, wherein creating the core data entry further comprises:
gathering, by executing a sharing rule engine, applicable sharing rules corresponding to the core data entry; and
determining, by executing the sharing rule engine, whether or not a configuration of one or more of the applicable sharing rules matches the core data entry.

18. The tangible machine-readable medium of claim 17, wherein the instructions, when executed by the one or more processors, further cause the machine to at least:
responsive to determining that the configuration of at least one of the applicable sharing rules matches the core data entry, creating the core data entry that includes the at least one of the applicable sharing rules.

19. The tangible machine-readable medium of claim 15, wherein the recipient party is a plurality of recipient parties, and the sharing rule includes a respective filtering requirement corresponding to each of the plurality of recipient parties.

20. The tangible machine-readable medium of claim 18, wherein the recipient party is a first recipient party, the identical data fragment update is a first identical data fragment update, the filtering requirement is a first filtering requirement, the filtered identical data fragment is a first filtered identical data fragment, the device associated with the first recipient party is a first device, and the instructions, when executed by the one or more processors, further cause the machine to at least:
determine to share the data fragment update with the first recipient party and a second recipient party without evaluating the sharing rule;
clone the data fragment update to generate a first identical data fragment update and a second identical data fragment update;
filter (i) the first identical data fragment update according to the first filtering requirement of the sharing rule and (ii) the second identical data fragment update according to a second filtering requirement of the sharing rule;
share the filtered first identical data fragment update with the first device associated with the first recipient party; and
share the filtered second identical data fragment update with a second device associated with the second recipient party.
